(19) United States
(12) Patent Application Publication
(10) Pub. No.: US 2013/0111342 A1
(43) Pub. Date: May 2, 2013

(54) Effective User Input Scheme on a Small Touch Screen Device

(71) Applicants: Rachid Mohsen Alameh, Crystal Lake, IL (US); Jiri Slaby, Buffalo Grove, IL (US)

(72) Inventors: Rachid Mohsen Alameh, Crystal Lake, IL (US); Jiri Slaby, Buffalo Grove, IL (US)

(73) Assignee: Motorola Mobility, Inc., Libertyville, IL (US)

(21) Appl. No.: 13/287,429

(22) Filed: Nov. 2, 2011

(51) Int. Cl. G06F 3/048

(52) U.S. Cl. 715/702

(57) ABSTRACT

Methods and small touch screen devices configured to perform the methods, wherein the methods include: detecting at least one tactile user input within a range of force and/or a duration of time at a central region of a touch screen; displaying at least one set of icons at one or more peripheral regions of the touch screen, due to the detecting of the at least one user input at the central region; and after detecting an other tactile user input at an icon of the at least one set of icons, executing, by a processing device, processing device readable instructions stored in a first memory device and linked to the icon of the at least one set of icons.

### FIELD OF THE INVENTION

The present invention relates to an effective user input scheme to switch between selectable icons on a small touch screen device.

### BACKGROUND

Portable electronic devices such as smart phones, personal digital assistants (PDAs), and tablets have become part of everyday life. More and more features have been added to these devices, and these devices are often equipped with powerful processors, significant memory, and operating systems, which allow for many different applications to be added. Commonly used applications facilitate functions such as calling, emailing, texting, image acquisition, image display, music and video playback, location determination (e.g., GPS), and internet browsing functions, among many others. Such devices are facilitating user access to these applications by having touch detecting surfaces, such as touch screens or touch pads, in addition to other known user input/output components. Further, such touch detecting surfaces, simply by touching a particular area of the surface and/or by moving a finger along the surface, are able to communicate instructions to control these electronic devices.

Often mobile electronic devices (such as smart phones) have limited display screen and user interface surface area due to the desire to keep the device portable; and this is especially the case where the device is wearable on a wrist of a user. Generally with such devices, as the touch screen is manufactured smaller the area in which selectable icons can be displayed becomes smaller, and thus, it is desirable to provide a mobile device with features to address such a concern.

### SUMMARY

In at least some embodiments, the present disclosure relates to methods and small touch screen devices configured to perform such methods. In at least some embodiments, the methods include detecting at least one tactile user input within a range of force and/or a duration of time at a central region (i.e., first region) of a touch screen, depending on the embodiment. Further the method includes, due to detecting the at least one user input at the central region, displaying at least one set of icons at one or more peripheral regions (i.e., second regions) of the touch screen. In the case where there are more than one of the at least one tactile user input there is a respective set of icons for each individual tactile input at the central region of the touch screen. Furthermore, after detecting an other tactile user input at an icon of the at least one set of icons at the one or more peripheral regions, executing, by a processing device, processing device readable instructions stored in a first memory device and linked to the icon located where the other tactile user input was detected.

Further, in at least some embodiments, the small touch screen devices include: a touch screen that displays a graphical user interface; a housing structure that supports the touch screen and internal components; and a processing device that is capable of executing first processing device readable instructions stored in a first memory device, wherein executing the first processing device readable instructions causes rendering of the graphical user interface on the touch screen and facilitates the aforementioned method.

Also, notwithstanding the above, in other example embodiments the central region need not be centrally located on the touch screen with respect to the one or more peripheral regions, and vice versa. For example, the “central” or the first region can be located on a bottom portion of the touch screen, and the “peripheral” or the second regions can occupy middle and/or top portions of the touch screen.

In one example embodiment of the disclosure, wherein due to ending the at least one tactile input to the first region, the at least on set of icons are locked at the one or more second regions until the input at the icon is detected. This occurs whether a user slides or lifts his or her finger or stylus from the first region to one of the one or more second regions. Given this, the user input at the one or more second regions can include sliding, pressing, or removing at least one of a finger, stylus, or the like at one of the one or more second regions. In contrast, the at least one user input at the first region includes only pressing a finger, stylus, or the like.

In another example embodiment of the disclosure, at least one piezoelectric sensor detects the at least one user input to the first region, and at least two piezoelectric sensors detect the user input to the one or more second regions by sensing tilt of a panel residing above the at least two piezoelectric sensors. Alternatively, solely or in addition to piezoelectric sensors, a capacitive touch screen panel, a resistive touch screen panel, and/or a thermal-sensitive touch screen panel can detect the user inputs to the first region and/or the second regions.

In a further embodiment of the disclosure, the touch screen device includes wristband fixtures that facilitate attaching a wristband to the touch screen device, and also includes toggling through a keypad in parts, such as toggling through a telephone keypad (depicted in FIGS. 6-8) or an alphanumeric keypad, so that a user can comfortably use a keypad on a user interface as small as a face of a wrist watch. Alternatively, the sets of icons can link to other functions of other applications, such as a function that initiates and executes an application.

### BRIEF DESCRIPTION OF THE DRAWINGS

FIG. 1 is a front view of an exemplary small touch screen device;

FIG. 2 is a block diagram of exemplary components of the small touch screen device of FIG. 1;

FIG. 3 is a side view of a possible arrangement of components of the small touch screen device of FIG. 1;

FIG. 4 illustrates an exemplary method for operating the small touch screen device of FIG. 1; and

FIGS. 5-10 are front views of example graphical user interfaces displayed by the touch screen of the small touch screen device of FIG. 1.

### DETAILED DESCRIPTION

Disclosed herein are touch screen devices and methods of using such devices that provide solutions for overcoming limitations related to touch screen size of small mobile electronic devices, for example, devices small enough to be worn on a wrist of user. The solutions include methods for toggling between sets of graphical user interface objects, such as icons that link to applications or operable components of one of the applications. For example, different sets of keys of a keypad can be switched through successively on a small touch screen that is too small to fit all the keys of the keypad comfortably. Additionally, larger touch screens can also benefit from these solutions. For example, this can be true in the case of magnifying a graphical user interface for the visually impaired or the elderly, who typically prefer larger graphical user interface objects and therefore have a lesser area to interact with such objects.

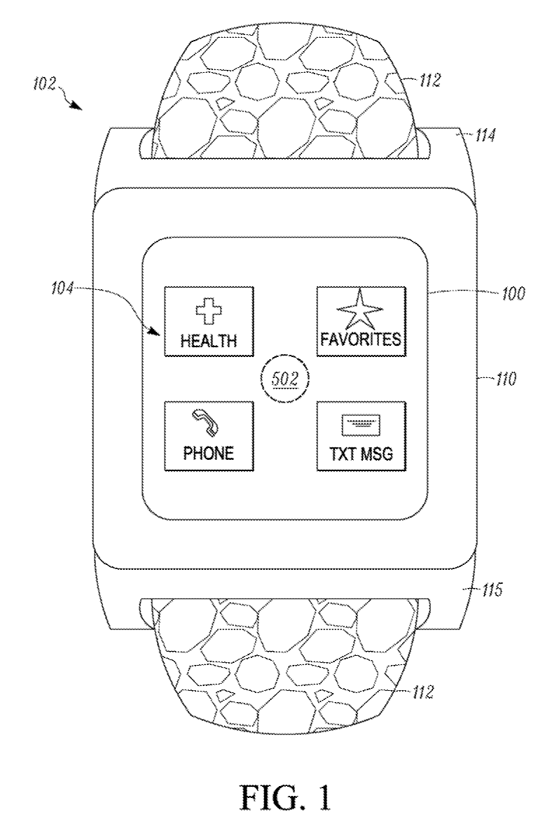

In at least some embodiments disclosed herein, the touch screen devices at least include a touch screen that is configured to display multiple sets of icons, and each respective set of icons is presented to a user when the user presses on a first region of the screen (e.g., a region 502 shown as a dashed circle in FIGS. 1, and 5-10) with a respective amount of force (within a range of force) and/or for a respective duration of time. That is each respective set of icons is associated with a respective amount of force (within a range of force) and/or a respective duration of time. Once the desired set of icons is displayed, then the user can select an icon from the desired set, which in turn causes an action, such as opening an application. Alternatively in some embodiments disclosed herein, the user can select multiple icons from the desired set, which in turn causes an action, such as opening multiple applications.

Additionally in at least some embodiments, after a desired set of icons is presented, the touch screen device is configured to detect a gesture from the user signaling the user's selection of the desired set of icons, and in turn, the device will lock the desired set of icons to its graphical user interface until one of the icons of the desired set is selected. For example, the user can signal that the desired set is present by moving his or her finger from the first region, which locks the icons in place until the user moves his or her finger over one of the icons, which in turn selects the icon and activates associated computer instructions. In an other example, first, a stylus or user's finger selects the desired set of icons, and then causes the icons to lock into place as soon as the device detects the user sliding the stylus or finger from the first region (or as soon as the stylus or finger is detected leaving the first region in a known manner such as being lifted from the first region). Then the user can select one of the icons by lifting the stylus or finger from the screen, so that selecting the desired set of icons and then one of the icons is a single gesture of pressing, sliding, and then lifting the stylus or finger. Such icon locking mechanisms are useful when a user wishes to use one hand; however, in at least some embodiments, the locking mechanisms are not as desired (e.g., embodiments where a user can use two hands).

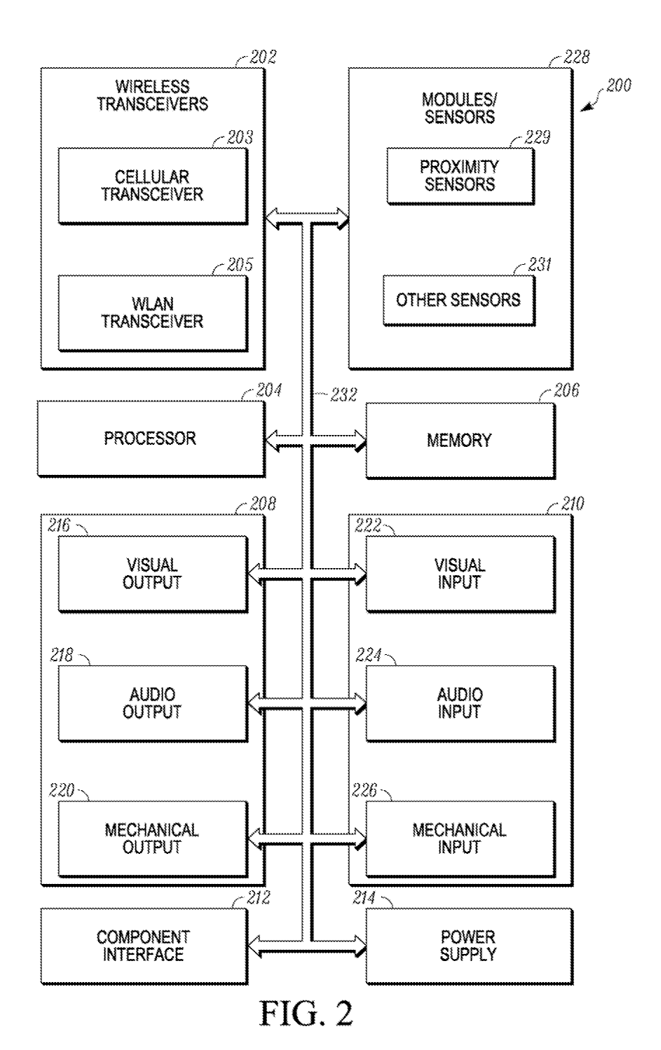

Referring now to FIG. 1, an exemplary small touch screen device 102 is illustrated which can take the form of a small mobile phone that in the present embodiment is configured to be worn on a user's wrist (as more fully described with respect to FIG. 2) and can include functions such as calling, emailing, texting, image acquisition, and internet browsing functions, as well as others. In other embodiments, the small touch screen device 102 can be any of a variety of other devices such as a personal digital assistant, remote controller, electronic book reader, or tablet. Although FIG. 1 depicts a small touch screen device, it should be further appreciated that the functions and components described herein are applicable to touch screen devices of all sizes. Furthermore, although the devices disclosed herein are not intended to be limited to devices that are small enough to be worn on a user's wrist, the device 102 of FIG. 1 particularly is configured to be worn on a user's wrist. As such, the device 102 includes structures 114 and 115 for attaching a wristband 112 to the device 102, where the structures respectively abut opposite sides of a housing 110 of the internal components of the device 102.

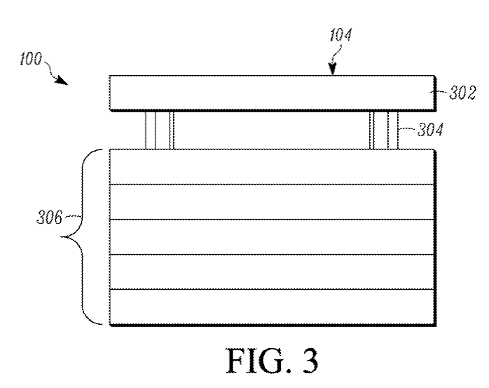

Referring still to FIG. 1, the small touch screen device 102 also includes a touch screen 100 that in the present embodiment includes a movement sensing assembly. Referring additionally to FIG. 3, such a movement sensing assembly can include a touch detecting surface 104, which can be part of a panel 302, and piezoelectric sensors 304 associated with a display screen 306 (also as shown in FIG. 3). For example, in at least some embodiments, at least one piezoelectric sensor detects user input to the first region (because detection of the input is only required at a single location), and at least two piezoelectric sensors detect user input to one or more of the icons by sensing tilt of a panel suspended above the at least two piezoelectric sensors (because detection of the input is required at multiple locations of a Cartesian plane. Alternatively, the touch detecting surface 104 can be any of a variety of known touch detecting technologies such as a resistive technology, a capacitive technology, an optical technology, a thermal sensing technology, or combination thereof. Further, in the embodiment of FIG. 3, the touch detecting surface 104 includes a light permeable panel (e.g., panel 302) or an other technology, which overlaps the display screen 306 (such as a liquid crystal display screen) that displays a graphical user interface.

Despite the above discussion of FIG. 3, in some alternative embodiments, the panel 302 need not be touch detecting. For example, the panel 302 can only be a sheet of light permeable glass or plastic, with the piezoelectric sensors 304 being the sole touch detecting mechanism of the touch screen 100. In other embodiments, piezoelectric sensors are not used, and one or a combination of the other touch detecting technologies performs touch detecting. Optionally, the device 102 can also include at least one key/button (e.g., popple style button) or a keypad having numerous keys for inputting various user commands for operation of the device 102.

The movement sensing assembly can alternately take other forms such as the sensing assembly shown and described in U.S. patent application Ser. No. 12/471,062, titled “Sensing Assembly For Mobile Device” and filed on Jan. 22, 2009. For example, such a sensing assembly can include a plurality of phototransmitters arranged to emit light outwardly in various directions, with at least one photoreceiver arranged to receive respective portions of transmitted light originating from each phototransmitter that has been reflected off an object (other configurations of phototransmitters and photoreceivers are also possible), and can also detect and identify various user gestures in contact or not in contact with the movement sensing assembly. For example, it can detect gestures that do not come into physical contact with the touch screen.

As noted, the small touch screen device 102 is operable to detect and identify various gestures by a user (where each gesture is a specified pattern of movement of an external object, such as a hand, one or more fingers, or a stylus, relative to the device 102), in one of a variety of known ways. The touch screen 100 is useful because changeable graphics can be displayed underlying the touch detecting surface 104 on which controlling gestures are applied. Various novel methods disclosed herein take advantage of this, as particularly described in detail following the below description of exemplary internal components of the device 102.

Referring to FIG. 2, a block diagram 200 illustrates exemplary internal components of a mobile smart phone implementation of the small touch screen device 102. These components can include wireless transceivers 202, a processor 204 (e.g., a microprocessor, microcomputer, application-specific integrated circuit, or the like), a memory 206 (which in at least some embodiments, the processor 204 and the memory 206 are on one integrated circuit), one or more output components 208, one or more input components 210, and one or more sensors 228. The device 102 can also include a component interface 212 to provide a direct connection to auxiliary components or accessories for additional or enhanced functionality, and a power supply 214, such as a battery, for providing power to the other internal components. All of the internal components can be coupled to each other, and in communication with one another, by way of one or more internal communication links 232, such as an internal bus.

The memory 206 can encompass one or more memory devices of any of a variety of forms (e.g., read-only memory, random access memory, static random access memory, dynamic random access memory, etc.), and can be used by the processor 204 to store and retrieve data. The data that is stored by the memory 206 can include operating systems, applications, and informational data. Each operating system includes executable instructions stored in a storage medium in the device 102 that controls basic functions of the electronic device, such as interaction among the various internal components, communication with external devices via the wireless transceivers 202 and/or the component interface 212, and storage and retrieval of applications and data to and from the memory 206.

As for programs (applications), each program includes executable code that utilizes an operating system to provide more specific functionality, such as file system service and handling of protected and unprotected data stored in the memory 206. Although many such programs govern standard or required functionality of the small touch screen device 102, in many cases the programs include applications governing optional or specialized functionality, which can be provided in some cases by third party vendors unrelated to the device manufacturer.

Finally, with respect to informational data, this non-executable code or information can be referenced and/or manipulated by an operating system or program for performing functions of the small touch screen device 102. Such informational data can include, for example, data that is preprogrammed upon the small touch screen device 102 during manufacture, or any of a variety of types of information that is uploaded to, downloaded from, or otherwise accessed at servers or other devices with which the small touch screen device 102 is in communication during its ongoing operation.

The small touch screen device 102 can be programmed such that the processor 204 and memory 206 interact with the other components of the device 102 to perform a variety of functions, including interaction with the touch detecting surface 104 to receive signals indicative of gestures there from, evaluation of these signals to identify various gestures, and control of the device in the manners described below. Although not specifically shown in FIG. 2, the processor 204 in at least some embodiments can include various modules and execute programs for detecting different gestures, such as toggling through various graphical user interface objects by pressing with a particular amount of force or for a particular duration of time at one or more specific areas of the touch screen 100. Further, the processor 204 can include various modules and execute programs for initiating different activities such as launching an application, data transfer functions, and the toggling through various graphical user interface objects (e.g., toggling through various icons that are linked to executable applications).

The wireless transceivers 202 can include, for example as shown, both a cellular transceiver 203 and a wireless local area network (WLAN) transceiver 205. Each of the wireless transceivers 202 utilizes a wireless technology for communication, such as cellular-based communication technologies including analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF, Bluetooth and IEEE 802.11 (a, b, g or n), or other wireless communication technologies.

Exemplary operation of the wireless transceivers 202 in conjunction with other internal components of the device 102 can take a variety of forms and can include, for example, operation in which, upon reception of wireless signals, the internal components detect communication signals and one of the transceivers 202 demodulates the communication signals to recover incoming information, such as voice and/or data, transmitted by the wireless signals. After receiving the incoming information from the one of the transceivers 202, the processor 204 formats the incoming information for the one or more output components 208. Likewise, for transmission of wireless signals, the processor 204 formats outgoing information, which can or can not be activated by the input components 210, and conveys the outgoing information to one or more of the wireless transceivers 202 for modulation as communication signals. The wireless transceiver(s) 202 convey the modulated signals to a remote device, such as a cell tower or an access point (not shown).

The output components 208 can include a variety of visual, audio, and/or mechanical outputs. For example, the output components 208 can include one or more visual output components 216 such as the display screen 106 or 306. One or more audio output components 218 can include a speaker, alarm, and/or buzzer, and one or more mechanical output components 220 can include a vibrating mechanism for example. Similarly, the input components 210 can include one or more visual input components 222 such as an optical sensor of a camera, one or more audio input components 224 such as a microphone, and one or more mechanical input components 226 such as the touch detecting surface 104 and the keypad 108 of FIG. 1.

The sensors 228 can include both proximity sensors 229 and other sensors 231, such as an accelerometer, a gyroscope, any haptic, light, temperature, biological, chemical, or humidity sensor, or any other sensor that can provide pertinent information, such as to identify a current location of the device 102.

Actions that can actuate one or more input components 210 can include for example, powering on, opening, unlocking, moving, and/or operating the device 102. For example, upon power on, a ‘home screen’ with a predetermined set of application icons can be displayed on the touch screen 100.

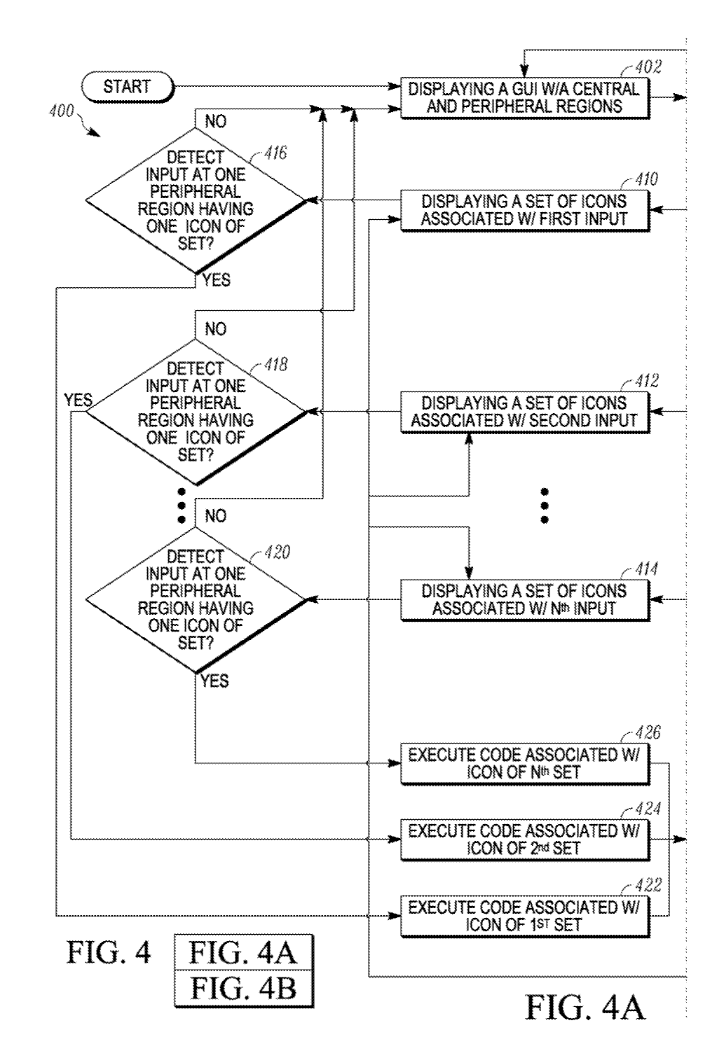

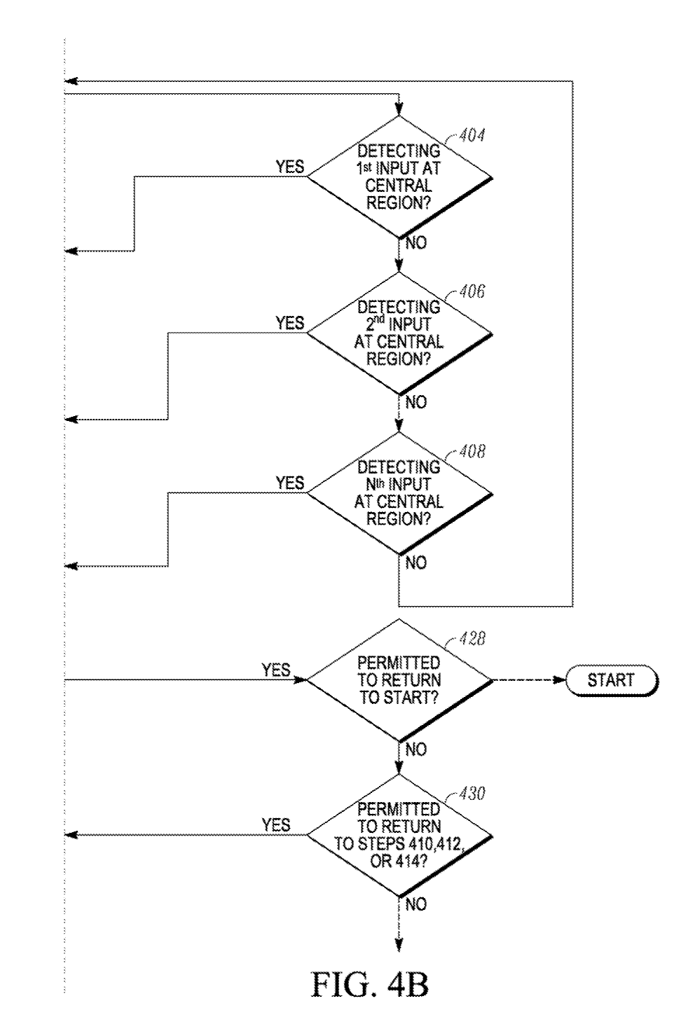

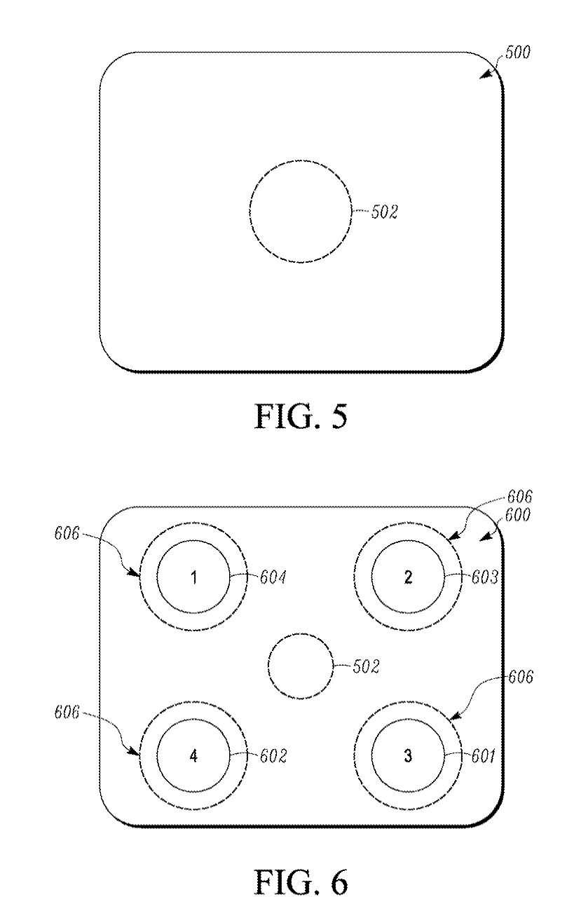

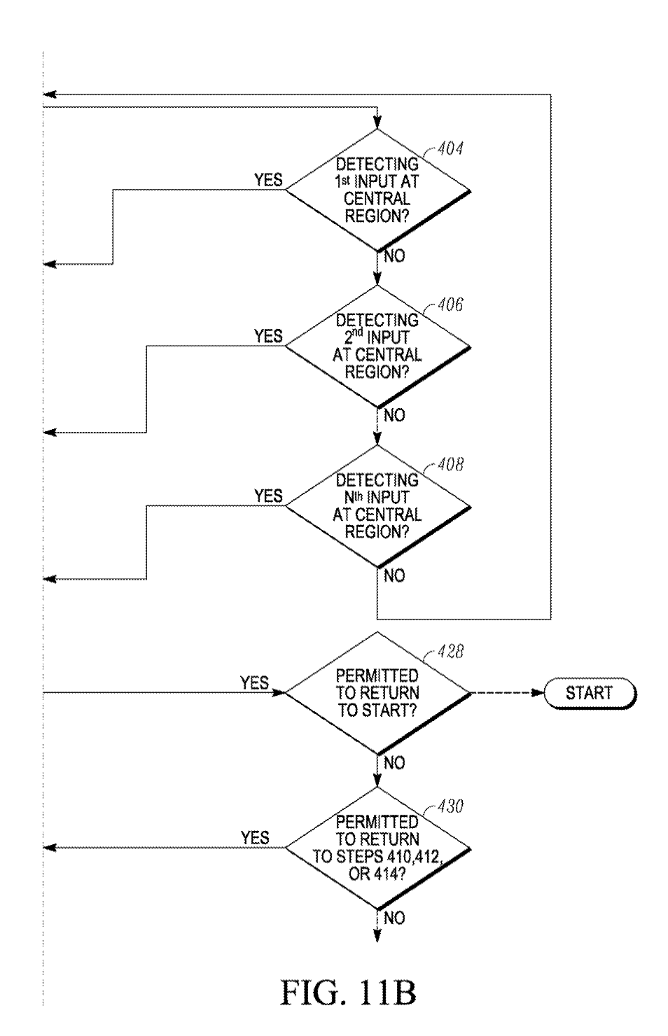

Turning attention to the novel methods, FIG. 4 illustrates an exemplary method 400 that can be performed by the small touch screen device 102, such as at a time when a set of application icons for selection are displayed on the touch screen 100. Additionally, to facilitate describing the methods, FIGS. 5-10 illustrate exemplary graphical user interfaces 500, 600, 700, 800, 900, and 1000 that can be displayed on the touch screen 100. The method 400 begins at a step 402, at which possibly a set of icons is displayed on the touch screen 100, and such icons are arranged in peripheral regions (e.g., regions 606 and 1006 of FIGS. 6 and 10 respectively) of the touch screen 100 relative to a central region (e.g., a region 502 of FIGS. 5-10). In this example, the central region does not contain an icon nor a set of icons, although in alternative embodiments an additional set of icons could be present in the central region. It is also possible that initially there are no icons displayed in any of the regions of touch screen. As noted herein, any given set of icons can include any arbitrary number of icons ranging from 1 to n.

Subsequent to the step 402 of the flowchart 400, at steps 404, 406, or 408, the touch detecting surface 104 can detect user inputs at the central region of the touch screen 100, such as a user's finger or a stylus pressing on the central region. As depicted in FIG. 4, the touch detecting surface 104 can detect 1 through n inputs. In one embodiment, the user input is actually at least one of possibly a set of user inputs that can be made at the central region, wherein the user inputs of the set vary from one another in terms of an amount of force that is applied to the central regions 502 (e.g., ranges of force for each user input of the set of user inputs at the central region) or in terms of a duration of time a range of force is applied to the central region (e.g., ranges of duration of time for each user input of the set of user inputs at the central region). If no input is detected from among the possible detectable inputs, then the process returns to the step 402.

Although the steps 404, 406, or 408 require tactile contact with the touch screen 100, in at least some alternative embodiments, tactile contact need not occur, but rather sensed gestures or voice command are enough.

At steps 410, 412, or 414, due to detecting one of the inputs at the central region, whether the input was an amount of force within a range or whether the input was pressing the user's finger or stylus against the central region for a specific duration of time (or range of time), the touch screen 100 displays a set of icons (e.g., sets of icons 601-604, 701-704, 801-804, 901-904, and 1001-1009 shown respectively in FIGS. 6-10) associated with that respective input, at the peripheral regions (e.g., the regions 606 and 1006 of FIG. 6 and FIG. 10, respectively). For example, one of the inputs at the central region can cause one icon to display in one of the peripheral regions if there is only one icon in the set, or there can be multiple icons in the set that occupy more than one of the peripheral regions of the touch screen 100.

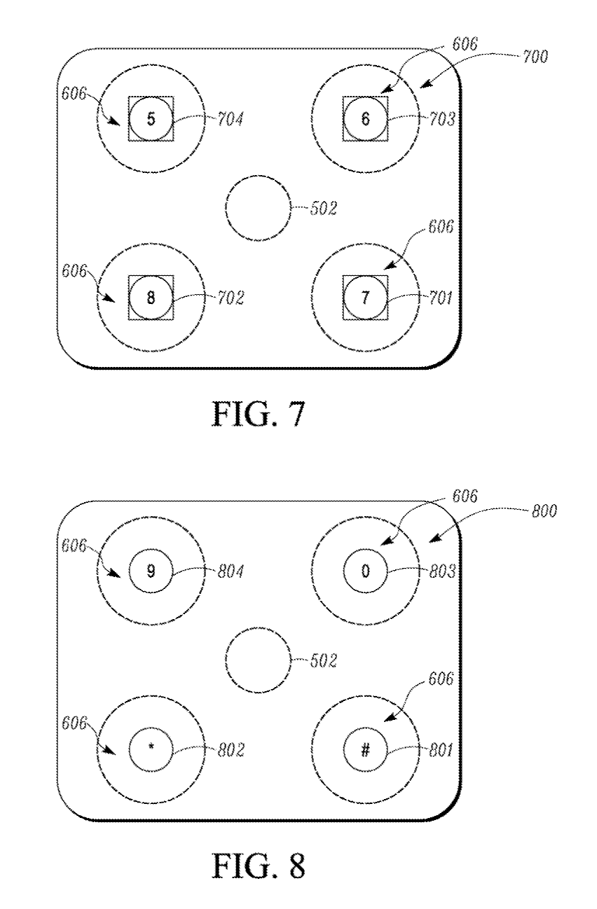

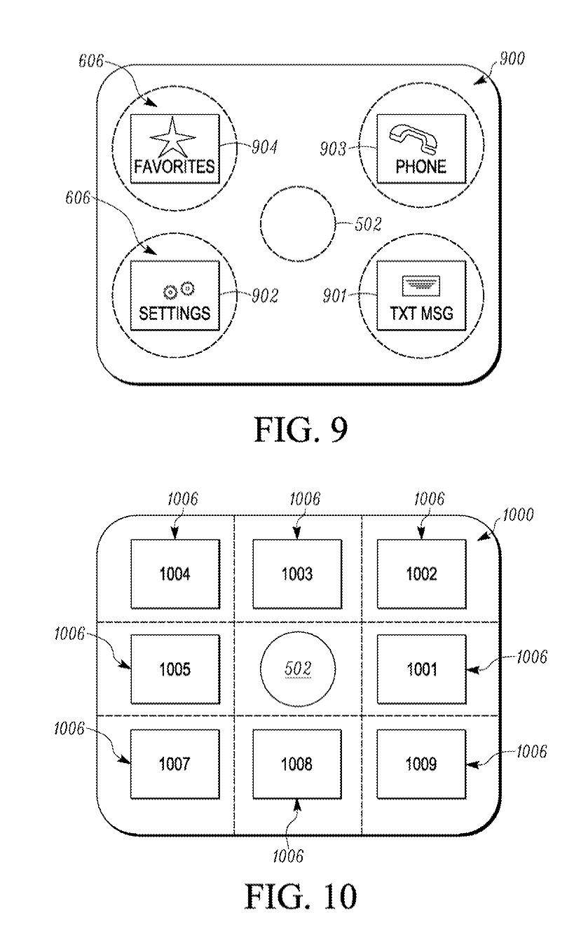

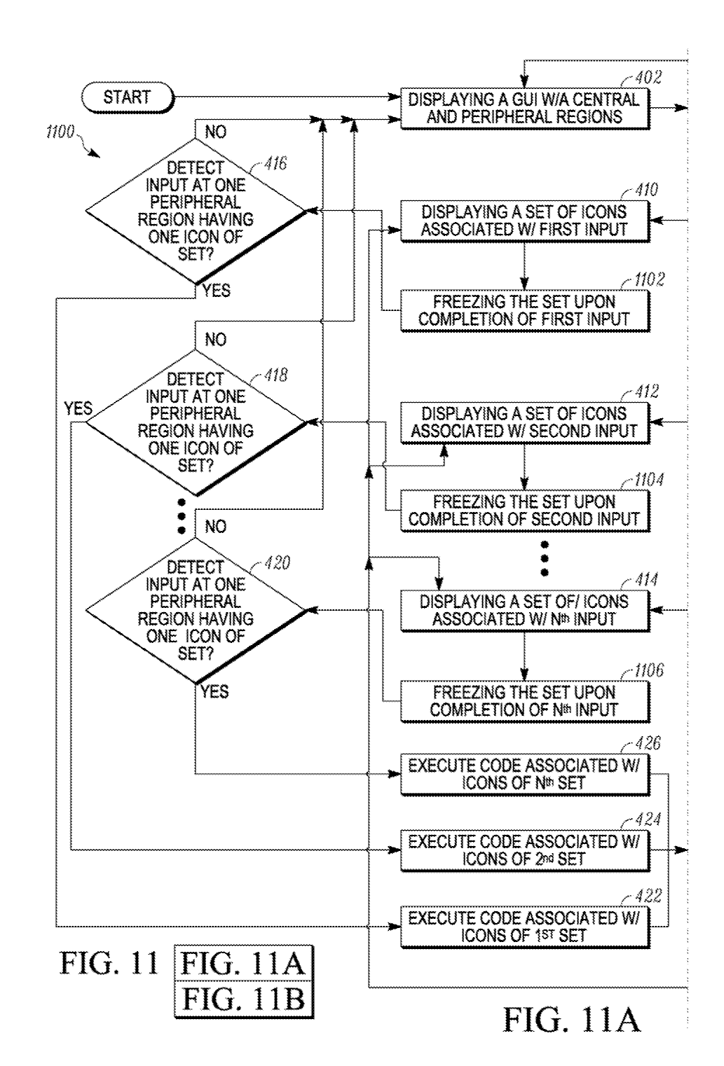

With reference to FIGS. 5-8, the user can press the central region 502 of FIG. 5 with a first amount of force within a range of force that causes the graphical user interface 600 of FIG. 6 to appear; or the user can apply a second or third amount of force within ranges of force that cause the graphical user interfaces 700 and 800 of FIG. 7 or 8 respectively. In these examples of FIGS. 6-8, it is apparent that such functionality allows for displaying keys of a telephone keypad separately in the peripheral regions 606 with the keys being of sufficient size and sufficiently spaced-apart so that the individual keys can be accurately pressed (FIG. 6 respectively show numbers 1-4, FIG. 7 respectively shows numbers 5-8, and FIG. 8 respectively shows numbers 9, 0, #, and *). By comparison, FIG. 9 presents an example of icons that are linked to applications that can be executed on the small touch screen device 102, and similarly to the previous example, a user can toggle through various sets of icons by providing different inputs at the central region 502 of the touch screen 100, e.g., at the steps 404, 406, and 408. As for FIG. 10, this figure illustrates a graphical user interface 1000 with eight peripheral regions 1006 as opposed to four regions 606 as shown in FIGS. 6-9. For the purpose of this disclosure, any number of peripheral regions can be provided depending upon the embodiments and in alternative embodiments not depicted there can also be more than one central region.

Referring still to FIG. 4, at step 416, 418, or 420 the touch detecting surface 104 detects a tactile user input (such as detecting the user touching the touch detecting surface 104) at one of the peripheral regions having an icon. In the example of the telephone keypad, shown in FIGS. 6-8, when a user touches one of the icons in one of the peripheral regions 606, the touch detecting surface 104 detects a user input analogous to an actual telephone keypad detecting pressing of a telephone keypad key.

Although not shown in FIG. 4, it should be appreciated that in some alternative embodiments additional steps can be performed, for example, at steps 1102, 1104, and 1106 (shown in FIG. 11), a method similar to method 400 (a method 1100) adds the respective steps 1102, 1104, and 1106, which includes locking of the respective set of icons of the peripheral regions selected by the respective user input at the central region after the respective user input at the central region is completed. For example, in a previously mentioned embodiment, first, a stylus or user's finger selects the desired set of icons, and then causes the icons to lock into place as soon as the device detects the user sliding the stylus or finger from the first region. Then the user can select one of the icons by lifting the stylus or finger from the screen, so that selecting the desired set of icons and then one of the icons is a single gesture of pressing, sliding, and then lifting the stylus or finger. Where such a locking step is not included, the set of icons of the peripheral regions can toggle unintentionally during the period of time between the input at the central region and the selecting of one of the icons in the peripheral regions. In at least some embodiments, this can be desirable, e.g., embodiments where a user can use two hands.

Referring back to FIG. 4, upon detecting the tactile user input at one of the icons at the peripheral regions at one of the steps 416, 418, or 420, respectively, code associated with the touched icon is executed at steps 422, 424, or 426, respectively; and once the code is executed, the method 400 can start again or return to one of the steps 410, 412, or 414, if permitted by the executed code 428 and 430 respectively.

For example, with reference to FIGS. 6-8, when a user touches one of the icons representing a key of a telephone keypad, such as the “9” key 804 of FIG. 8, upon detecting the user input to the key 804 (e.g., the steps 416, 418, or 420), the processor 204 executes processor executable instructions that causes dialing that first number (e.g., 422, 424, or 426). Once the dialing of the first number occurs, the user can perform one of the detectable inputs to the first region (e.g., the steps 404, 406, or 408 subsequent the step 402), which can toggle the sets of keys, or the user can perform another detectable input to one of the peripheral regions having an icon (e.g., the steps 416, 418, or 420 subsequent the steps 410, 412, or 414 respectively), which dials a second number.

Again referring particularly to FIG. 9, in one embodiment, upon activating the touch screen device, the touch screen 100 can display the graphical user interface 900 of FIG. 9. Using this interface a user can input at the central region 502 various inputs (e.g., as represented by the steps 404, 406, and 408 of FIG. 4) to toggle through icons (e.g. the icons 901-904) linked to applications stored on a storage medium of the device 102. For example, the icon 904 labeled “FAVORITES” in FIG. 9, links to a graphical user interface displaying applications, web pages, and the like predetermined by a user. The user after arriving at a desired set of icons can slide, press, or lift his or her finger or a stylus, depending on the embodiment, to an icon located at one of the peripheral regions 606, such that an input is detected (e.g. as represented by steps 416, 418, and 420 of FIG. 4). For example, the user can move a stylus to the peripheral region 606 of FIG. 9 having the “PHONE” icon 903. The touch detecting surface 104 upon detecting tactile input at “PHONE” icon 903 (or such other icon that is selected), in turn communicates to the processor 204 to run code that executes a telephone application, which can upon execution render a graphical user interface 600 such as the one depicted in FIG. 6. At this point, a user can dial a phone number by pressing one of the displayed keys and/or by toggling to other sets of keys per the method depicted in FIG. 4. Alternatively, for example, a user can toggle to a set of icons having the “TXT MSG” icon 901, and then similarly select the icon to execute a text messaging application, wherein then the text messaging application allows a user to toggle through various alpha/numeric keys so that text messaging is possible on the small touch screen 100.

The disclosed methods and the small touch screen devices that perform these methods provide solutions for overcoming limitations related to the screen size of small mobile electronic devices, for example, devices small enough to be worn on a wrist of user. By providing methods for toggling through application icons and various graphical user interfaces of mobile device applications, some disadvantages of a smaller screen can be overcome. Given the functionality illustrated by FIGS. 6-8, it should be appreciated that, even though the touch screen device 102 has a touch screen as small as a face of a wrist watch, a user is nonetheless able to dial a phone number by toggling through various keys of a telephone keypad and there need be no effort to fit all of the keys on such a small user interface. Additionally, although such toggling solutions are beneficial to small touch screens, larger touch screens can also benefit from these solutions. For example, in the case of magnifying a graphical user interface for the visually impaired or the elderly, who typically prefer larger graphical user interface objects and therefore have lesser area to interface with such objects. Furthermore, keyboards with thousands of characters, such as keyboards for various sets of Chinese characters, can benefit from these solutions.

It is specifically intended that the present invention not be limited to the embodiments and illustrations contained herein, but include modified forms of those embodiments, including portions of the embodiments and combinations of elements of different embodiments as come within the scope of the following claims.

We claim:

1. A touch screen device comprising:
a touch screen that displays a graphical user interface;
a housing structure that supports the touch screen; and
a processing device that is capable of executing first processing device readable instructions stored in a first memory device, wherein executing the first processing device readable instructions causes rendering of the graphical user interface on the touch screen and facilitates the following method:
detecting at least one tactile user input within a range of force at a central region of the touch screen;
displaying at least one set of icons at one or more peripheral regions of the touch screen due to the detecting of the at least one tactile user input, wherein the case where there are more than one of the at least one tactile user input there is a respective set of icons for each of the at least one tactile user input at the central region of the touch screen;
detecting an other tactile user input at an icon of the at least one set of icons at the one or more peripheral regions; and
executing, by the processing device, second processing device readable instructions stored in the first memory device and based upon the detecting of the other tactile user input.

2. The touch screen device of claim 1, wherein due to ending the at least one tactile user input at the central region of the touch screen, the at least one set of icons is locked at the one or more peripheral regions until the other tactile user input is detected.

3. The touch screen device of claim 1, further comprising wristband attachment structures that facilitate attaching a wristband to the touch screen device of claim 1.

4. The touch screen device of claim 1, wherein at least one piezoelectric sensor detects the at least one tactile user input at the central region of the touch screen.

5. The touch screen device of claim 1, wherein a capacitive touch screen panel detects the at least one tactile user input at the central region of the touch screen.

6. The touch screen device of claim 1, wherein a resistive touch screen panel detects the at least one tactile user input at the central region of the touch screen.

7. The touch screen device of claim 1, wherein a thermal-sensitive touch screen panel detects the at least one tactile user input at the central region of the touch screen.

8. The touch screen device of claim 1, wherein at least two piezoelectric sensors detect the other tactile user input by sensing tilt of a panel residing above the at least two piezoelectric sensors.

9. The touch screen device of claim 1, wherein the touch screen includes a capacitive touch screen panel and one or more nodes of the touch screen detect the other tactile user input by sensing at least one of a user's finger, a capacitive touch screen compatible stylus, or the like.

10. The touch screen device of claim 1, wherein the touch screen includes a resistive touch screen panel and one or more nodes of the touch screen detect the other tactile user input by sensing at least one of a user's finger, stylus, or the like.

11. The touch screen device of claim 1, wherein the touch screen includes a thermal-sensitive touch screen panel and one or more nodes of the touch screen detect the other tactile user input by sensing at least one of a user's finger, stylus, or the like.

12. The touch screen device of claim 1, wherein the sets of icons are keys of a phone keypad and the detecting of the other user input results in executing, by the processing device, the second processing device readable instructions, which in this case represent dialing on a phone.

13. The touch screen device of claim 1, wherein the icon of the sets of icons link to respective computer applications and the detecting of the other user input results in executing, by the processing device, the second processing device readable instructions, which in this case represent one of the respective computer applications.

14. The touch screen device of claim 1, wherein the other user input includes at least one of sliding, pressing, or removing at least one of a finger or a stylus at one of the peripheral regions.

15. The touch screen device of claim 1, wherein the at least one tactile user input at the central region of the touch screen includes pressing at least one of a finger or a stylus at the central region.

16. A touch screen device comprising:
a touch screen that displays a graphical user interface;
a housing structure that supports the touch screen; and
a processing device that is capable of executing first processing device readable instructions stored in a first memory device, wherein executing the first processing device readable instructions causes rendering of the graphical user interface on the touch screen and facilitates the following method:
detecting at least one tactile user input, having a duration of time, at a first region of the touch screen;
displaying at least one set of icons at one or more peripheral regions of the touch screen due to the detecting of the at least one tactile user input, wherein the case where there are more than one of the at least one tactile user input there is a respective set of icons for each of the at least one tactile user input at the first region of the touch screen;
detecting an other tactile user input at an icon of the at least one set of icons at the one or more peripheral regions; and
executing, by the processing device, peripheral processing device readable instructions stored in the first memory device and based upon the detect of the other tactile user input.

17. A method, comprising:
detecting at least one tactile user input within a range of force at a central region of a touch screen;
displaying at least one set of icons at one or more peripheral regions of the touch screen due to the detecting of the at least one tactile user input, wherein the case where there are more than one of the at least one tactile user input there is a respective set of icons for each of the at least one tactile user input at the central region of the touch screen;
detecting an other tactile user input at an icon of the at least one set of icons at the one or more peripheral regions; and
executing, by the processing device, second processing device readable instructions stored in the first memory device and based upon the detecting of the other tactile user input.

18. The method of claim 17, wherein due to ending the at least one tactile user input at the central region of the touch screen, the at least one set of icons is locked at the one or more peripheral regions until the other tactile user input is detected.

19. The method of claim 17, wherein subsequent the code being executed, the method of claim 17 can return to the detecting of the at least one tactile user input at the central region of the touch screen, if permitted by the executed code.

20. The method of claim 17, wherein subsequent the code being executed, the method of claim 17 can return to the displaying of the at least one set of icons at the one or more peripheral regions of the touch screen, if permitted by the executed code.
